(19) United States
(12) Patent Application Publication
(10) Pub. No.: US 2019/0236897 A1
(43) Pub. Date: Aug. 1, 2019

(54) SYSTEM AND METHOD FOR TRANSFORMING CASINO PLAYER GAMING DATA TO A GRAPH DATABASE FOR THE DEVELOPMENT OF BUSINESS-CENTRIC SOFTWARE COMPONENTS

(71) Applicant: JOSEPH PETER STEFANIAK, San Clemente, CA (US)

(72) Inventor: JOSEPH PETER STEFANIAK, San Clemente, CA (US)

(21) Appl. No.: 15/881,791

(22) Filed: Jan. 28, 2018

(51) Int. Cl. G07F 17/32; G06F 17/30

(52) U.S. Cl. CPC G07F 17/3237; G06F 17/30002; G07F 17/3227

(57) ABSTRACT

A method in a computer system is disclosed for discovering casino-based player and play data. The system has a client, a server and a host, including a graph database. The method comprises the steps of creating an application object comprising a collection of the casino-based player and play data; and, creating a recognition file for storing constituent elements of the casino-based player and play data. After this, the first stream of data representative of the casino-based player and play data is received from the host in response to a request by the client for data fields. Next, the first data stream is parsed into constituent elements and stored in the recognition file and then the constituent elements are associated with the casino-based player and play data. The constituent elements of the first data stream are appended to the recognition file for the casino-based player and play data; and, then they are associated with data names that are stored in the graph database, thereby creating a specification for each of said casino-based player and play data.

### BACKGROUND OF THE INVENTION

The software industry has seen great advances in distributed computing from both a client/server and software modeling perspectives. The move towards network-centric computing, using the client/server architecture of the Internet, coupled with new software tools and data-driven models, equip today's software developer with a distributed, object-oriented, infrastructure that affords ease of access and manipulation of business data.

In the early nineties, as client-server computing emerged; more advanced software solutions introduced more intelligent links among clients and servers. Although it represents an improvement over earlier models, client-server computing still suffers from a number of drawbacks. For example, since information carried between clients and servers is usually transmitted over a proprietary protocol, each user tends to implement a closed solution, i.e., a solution that works only for the product of that user.

In the current scenario, distributed data-driven development and enabling solutions are changing the way information is discovered, built, managed and delivered. Organizations are investing in data-driven technologies because they cannot afford to ignore the reductions in costs that the new technology offers. As a method for delivering information to large numbers of end-users, the iterative process of building and deploying components are appealing when compared with the alternative of configuring every end-user system with application-specific client applications.

A reduction in the overall costs is just one benefit. Other benefits include access to larger amounts of enterprise information for connecting the organization, delivering solutions and keeping pace with end-user demands, and being able to take advantage of ever changing technology more effectively. Effective business processes require information, and the objective for the Information System (IS) organizations is to ensure that the required information is available when it is needed.

The present invention re-uses existing business assets in new data-driven paradigms. It employs a method that enhances the efficiency of the current technology and reduces its drawbacks.

### FIELD OF THE INVENTION

The present invention generally relates to the field of computer systems for developing business applications; and, in particular, it relates to a system and computer-implemented method for providing access to casino-based player and play data for the development of business-centric software components using data-driven models.

### DESCRIPTION OF RELATED ART

The Graph Database is a database that uses graph structures for semantic queries with nodes, edges and properties to represent and store data built using data-driven models. Data-driven model is where the data itself controls the meaning and relationships of the program and not the program logic. A key concept of the system is the graph (or edge or relationship), which directly relates data items in the store via relationships contained in the data-driven model. The relationships allow data in the store to be linked together directly, and in many cases retrieved with one operation.

This contrasts with relational databases that, with the aid of relational database management systems, permit managing the data without imposing implementation aspects like physical record chains; for example, links between data are stored in the database itself at the logical level using model-driven models, and relational algebra operations (e.g. join) can be used to manipulate and return related data in the relevant logical format. The execution of relational queries is possible with the aid of the database management systems at the physical level (e.g. using indexes), which permits boosting performance without modifying the logical structure of the database.

Thus, Graph databases, by design, allow simple and fast retrieval of complex hierarchical structures that are difficult to model in relational systems and are derived through data-driven models. Graph databases are similar to 1970 network databases in that both represent general graphs, but network-model databases operate at a lower level of abstraction and lack easy traversal over a chain of edges.

### SUMMARY OF THE INVENTION

In accordance with the present invention a system is provided that reduces overall costs while efficiently accessing large amounts of enterprise information for connecting the casinos player and play data, delivering solutions and keeping pace with end-user demands for ever-changing technology.

An advantage of the present invention is the use of graph-based technology, which embraces the entire realm of a casino's information infrastructure. Graph-based technologies can take advantage of differing client platforms, diverse application environments and connectivity options.

An object of the present invention is to provide a system where organizations may re-use casino-based player and play data in graph-based frameworks.

Another object of the present invention is to provide a system that can discover player and play data of a casino.

Yet another object of the present invention is to provide a system that stores the casino-based player and play data of an organization as specifications that can be used to generate components irrespective of the underlying middleware implementation.

Still another object of the present invention is to provide a method and system that permits an organization to associate a casino-based player and play data specification to a graph-based implementation, which would otherwise not be possible.

Another object of the present invention is to provide a system that permits an organization to achieve levels of information enabling, through data-driven model development, which would otherwise not be possible.

Still other objects, features and advantages of the present invention will become readily apparent to those skilled in the art from the following detailed description, wherein is shown and described only the preferred embodiment of the invention, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims. The present invention will become apparent when taken in conjunction with the following description and attached drawings, wherein like characters indicate like parts, and which drawings form a part of this application.

### BRIEF DESCRIPTION OF THE DRAWING

FIG. 1 is a block diagram of a computer system framework which may employ the method and system of the present invention.

FIG. 2 is a software module block diagram of the method and system of a theoretical model of the present invention.

FIG. 3 is a use case diagram of the present invention.

FIGS. 4A and 4B combined form an overall flow chart of the method of the present invention.

FIG. 5 is a detailed graph model representing the player and play data of the method and system of present invention.

### DETAILED DESCRIPTION OF ONE EMBODIMENT

Before proceeding with a description of the system and method of the present invention, a summary of terminology used herein is provided, which may be helpful in understanding the disclosed embodiment.

A graph database node is an abstract representation of a real-world concept or thing. For example, a node can be used to represent a customer account in a banking application. A node has features, which can be either a relationship or a property. A relationship defines a directional or non-directional connection between two nodes. A relationship will always have two nodes. For example, “owns” could be defined as a relationship between a “Guest” and “Games” node. Properties indicate the state of an object. Every property of a node has a value, and it is the property values that define the state of the node. A property defines a value that is stored within the node. For example, “zip code” could be a property of the “Guest” node. The numeric value for the guest's zip code would be stored in the “Guest” node. A reference is a link or pointer to another node, and implies a relationship to that other node. A reference is typically used when it is desired not to duplicate data or where a property can contain more than one value. For example, the “Guest” node could store the guest's zip code as a property. However, if the guest has moved across multiple zip codes, the guest's zip code would have multiple property values. Therefore, it is desirable to define a separate “Zip” node and place the zip code as a property of the “Zip” node. The “Guest” node would then contain a reference to each of the “Zip” nodes.

A normal program stores nodes in a computer system's memory. When the program terminates, the memory used by those nodes is freed and reused by other programs, making the nodes that the program stored transient. A graph database stores nodes in a non-volatile memory, such as a computer disk. Since the information on a computer disk remains in existence, even when the computer is turned off, a graph database provides the ability to persistently store nodes. An node based program that uses a graph database thus has the option of storing nodes transiently or persistently.

Modeling the world as nodes, relationships and properties and then implementing them in an object-oriented system is the basis of object-oriented technology. Corporations are just beginning to apply the concepts of object technology to the business itself. Anything that is related to the finances, products, or customers of an enterprise can be a business object and work as part of a cooperative business object system. Business objects represent things, processes or events that are meaningful to the conduct of a business. Business objects make sense to business people. More specifically, a business object is a representation of an active thing in the business domain, including at least its business name and definition, attributes, behavior, relationships, rules, policies and constraints. Typical examples of business objects are an employee, a product, an invoice or payment receipt. Business objects do not have to be written in an object-oriented language.

A node represents the business object abstraction, which models the real world in the information system. Each such node in the information model is a component of that information model and must be supported by a technology infrastructure. The discovery phase is characterized by the capturing of source information. A unit of source information is characterized as containing enough information to allow it to be effectively modeled. Source information can include the player data and player play from output of legacy transactions, documents, data base records, etc.

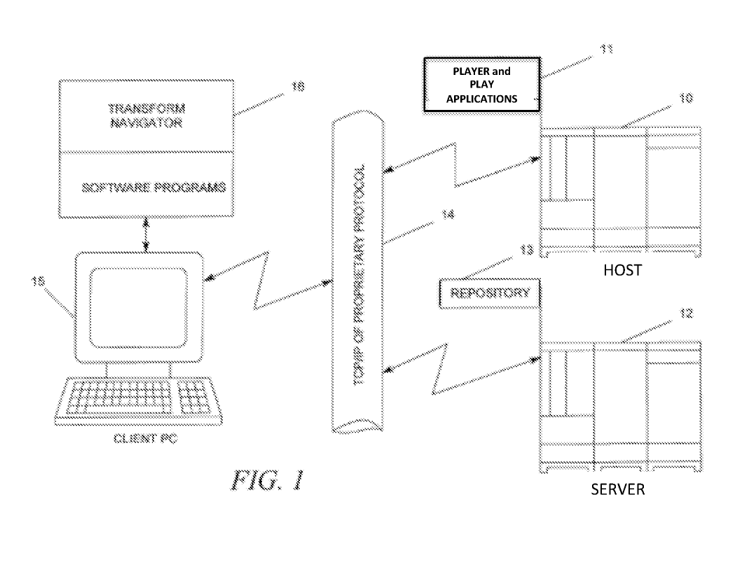

Referring now to FIG. 1, a system configuration is illustrated, including a server host 10 executing many computer programs, including casino player and play data applications 11. Also, a server 12 executes many programs, including a graph database program 13. The server host 10 and the server 12 are coupled to a TCP/IP connection 14, which in turn is coupled to a multiplicity of clients, such as a client PC 15. The PC 15 is capable of executing software programs 16 including a transform navigator.

In the disclosed embodiment, the repository program 13 is a specialized, extensible graph database application that adds value to a database system, which allows customization of a particular domain (such as application development).

The repository program 13 further includes methods for cataloging, browsing, searching, and managing components that make up an application.

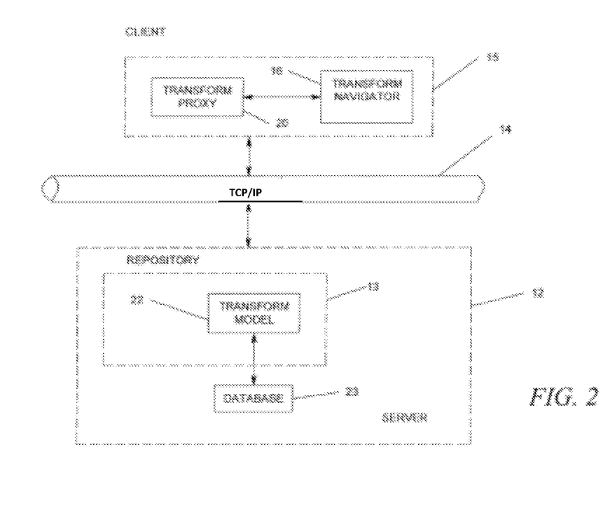

Referring now to FIG. 2, a block diagram of a software module block diagram of the method and system of a theoretical model of the present invention is shown. Various modules used for building and transforming casino player and play data on a host application into software components useful in developing business-centric applications are illustrated. Within the PC 15 is a transform proxy 20, which is a JAVA compliant component that provides the capability to access the transform navigator 16. The transform proxy 20 communicates directly with the TCP/IP 14, which in turn communicates directly with a transform model 22 within the repository program 13 being executed by the server 12.

A graph database 23 is accessible by the repository 11 for the storage and retrieval of casino player and play data specifications.

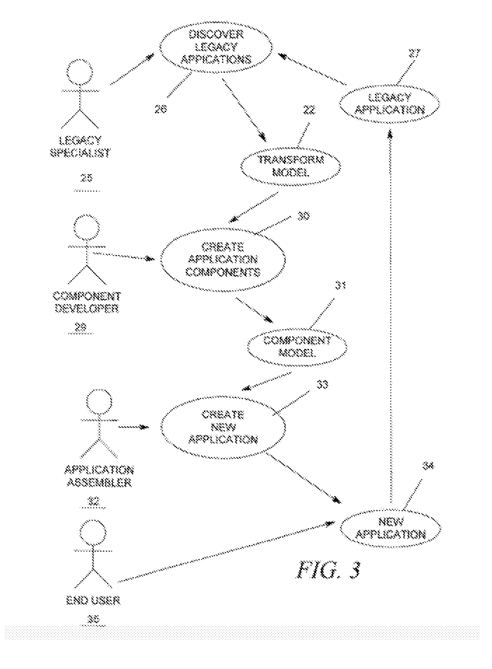

Referring now to FIG. 3, a use case diagram of the present invention is shown. The first act to be performed is by a legacy specialist 25, who discovers 26 a legacy application 27 by use of the present invention. The result of the discovery operation 26 produces the transform model 12 in accordance with the present invention. A component developer 29 uses the transform model 12 to create application components 30, which in turn are used to generate a component model 31.

An application assembler 32 uses the component model 31 to create 33 a new application 34. The new application 34 is run in parallel with the legacy application 27 by an end user 35. Accordingly, the legacy application 27 may be reused in a component-based framework, such as the new application 34. As will be shown in greater detail herein below, a method and system is provided that includes an iterative process for building and deploying components as illustrated in FIG. 3. Such a method and system allows the delivery of information to large numbers of end-users without configuring every end-user system with application-specific client applications.

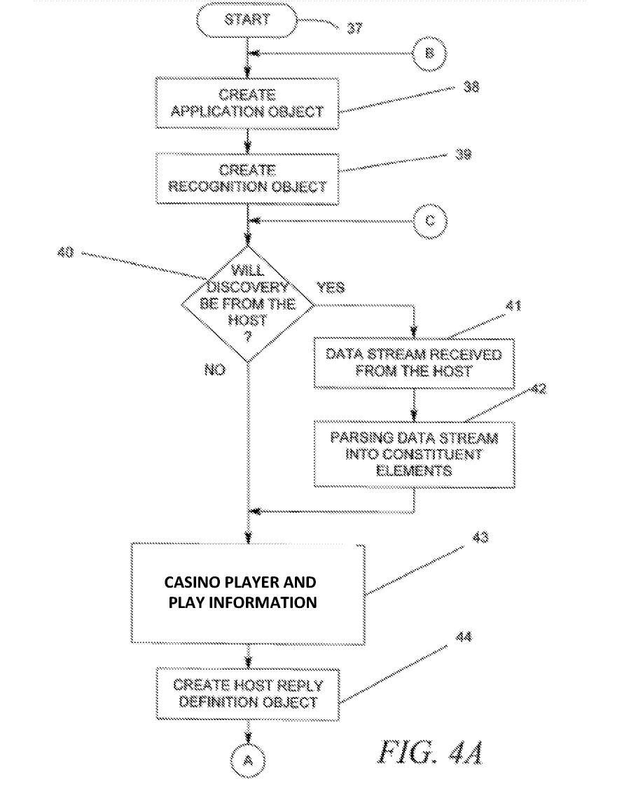

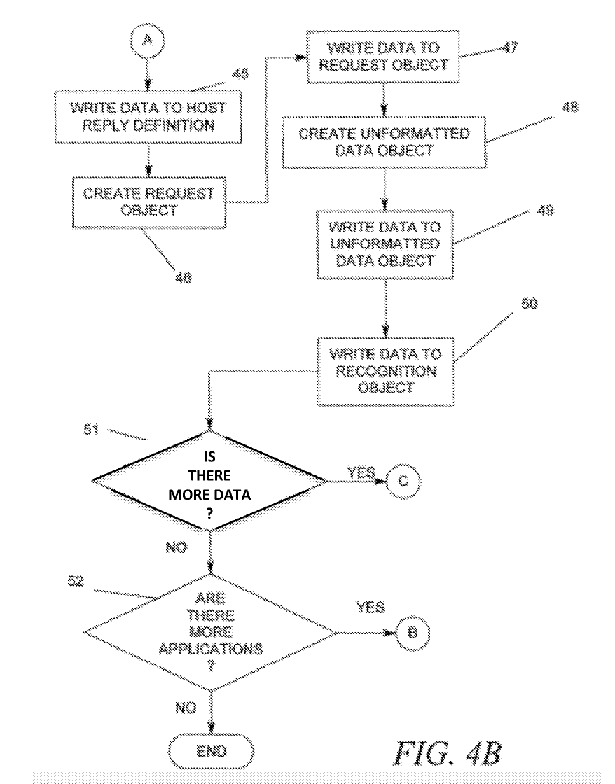

Referring now to FIGS. 4A and 4B, a flow chart of the method of the present invention is shown. The process begins with a start bubble 37 followed by a step of creating an application object (block 38). The Application class of objects includes attributes that specify the set of Users that have access to this Application; the set of Common Files that belong to this Application and a set of objects that provide a host connection for this Application. Next, a recognition object is created (block 39) for storage of application level data. After this, a data stream representative of a casino player and play data from the host is parsed into its constituent elements (block 40). Next, an inquiry is made as to whether or not discovery of the legacy application will be from the host (diamond 40). If the answer to this inquiry is yes, then a data stream is received from the host (block 41) and then parsed into its constituent elements (block 42).

On the other hand, if the answer to this inquiry is no, or upon completion of the step depicted by the block 42, casino player and play data information is received (block 43).

After completion of the above, a host reply definition object is created (block 44), which represents the host reply definitions (HRD) file. The process illustration continues in FIG. 4B as denoted by a connector A.

Referring now to FIG. 4B at the connector A, data is written to the host reply definition object (block 45) and a request object is created (block 46). A request class of objects stores a request. Request data is next written to the request object (block 47) and an unformatted data object is created (block 48). The unformatted data class of objects is a general purpose file for storing data of any kind.

Next, casino player and play data is written to the unformatted data object (block 49) and application level data is written to the recognition data object (block 50). Following the above, an inquiry is made as to whether or not there is more casino player and play data (diamond 51). If the answer to this inquiry is yes, then a return is made back to the block 41 (FIG. 4A) as denoted by a connector C. On the other hand, if the answer to this inquiry is no, then another inquiry is made as to whether or not there are more applications (diamond 52). If the answer to this second inquiry is yes, then a return is made back to the block 43 (FIG. 4A) as denoted by a connector B. On the other hand, if the answer to this inquiry is no, then the process ends.

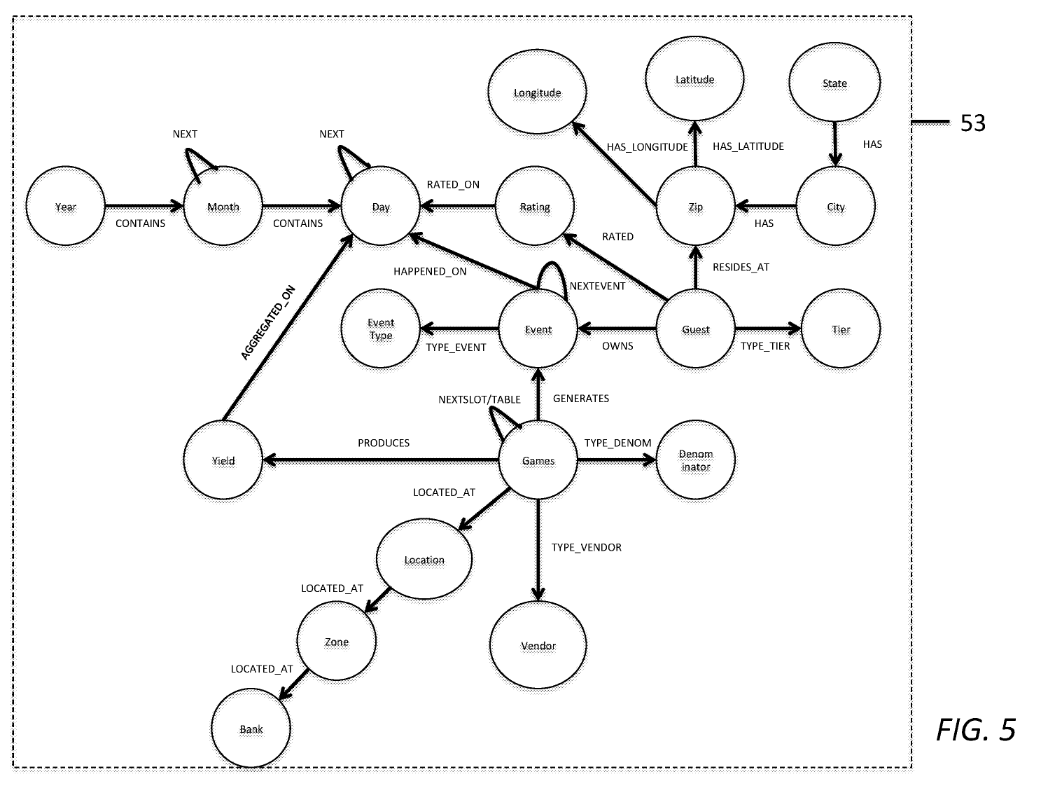

Referring now to FIG. 5 a model including nodes and relationships of the casino player and play data is represented as a graph model (block 53)

The methods and apparatus of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described with reference to a specific embodiment, this description is not meant to be construed in a limiting sense. Various modifications of the disclosed embodiment as well as alternative embodiments of the invention will become apparent to one skilled in the art upon reference to the description of the invention. It is therefore contemplated that the appended claims will cover any such modifications of embodiments that fall within the true scope of the invention.

### DETAILED DESCRIPTION OF THE INVENTION

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. In a computer system having a client, a server and a host, including a repository, a method for discovering casino player and play data, said method comprising the steps of:
a) creating an application object comprising a collection of said player and play data;
b) creating a recognition file for storing constituent elements of said player and play data;
c) receiving a first stream of data representative of said player and play data from said host in response to a request by said client for data fields;
d) parsing said first data stream into constituent elements, storing the same in said recognition file and associating said constituent elements with said player and play data;
e) appending said constituent elements of said first data stream to said recognition file for said player and play data; and,
f) associating said constituent elements of said player and play data with data names that are stored in said repository, thereby creating a specification for each of said player and play data.

2. The method as in claim 1 further comprising the steps of:
a) creating a host reply object for said constituent elements of said player and play data for associating said data names with data values of said data stream received from said host;
b) creating a request object for said constituent elements of said player and play data for associating said data names with data values to create a second data stream to be transmitted to said host; and,
c) repeating all of the steps in claims 1 and 2 hereof.

3. The method as in claim 1 further comprising the steps of:
a) appending said recognition file for said constituent elements for each of said player and play data stored in said server; and,
b) storing said recognition file for said player and play data stored in said server.

4. The method according to claim 3 further including the step of associating said constituent elements with data names stored in said server.
